(19) United States
(12) Patent Application Publication
(10) Pub. No.: US 2025/0283544 A1
(43) Pub. Date: Sep. 11, 2025

(54) CONTROL MANIFOLD AND METHOD FOR TANK CLEANING

(71) Applicant: WOLF PROCESS TECHNOLOGY, LLC, Katy, TX (US)

(72) Inventor: Mark Ernest WOLF, Katy, TX (US)

(21) Appl. No.: 18/961,695

(22) Filed: Nov. 27, 2024

Related U.S. Application Data
(60) Provisional application No. 63/562,086, filed on Mar. 6, 2024.
(60) Provisional application No. 63/710,198, filed on Oct. 22, 2024.

(51) Int. Cl. F16K 11/22; B01D 21/24; B08B 9/08; B08B 13/00; B60P 3/22

(52) U.S. Cl. CPC F16K 11/22; B01D 21/2444; B08B 9/08; B08B 13/00; B60P 3/224; B08B 2209/08

(57) ABSTRACT

An independent control manifold is configured to handle supplying a cleaning fluid to, and extracting a sediment from an operational tank, The control manifold includes a supply block configured to receive the cleaning fluid from an external first tank and to supply the cleaning fluid to the operational tank; a discharge block configured to receive the sediment from the operational tank and to supply the sediment to an external second tank; and a venturi eductor that fluidly connects the supply block to the discharge block, and is configured to either extract the sediment from the operational tank or to recover the cleaning fluid.

### BACKGROUND OF THE INVENTION

### Technical Field

Embodiments of the subject matter disclosed herein generally relate to an independent control manifold, associated system, and method for removing sediment from inside a tank using the control manifold.

### Discussion of the Background

In the chemical field, for example, oil and gas refineries, there are many operations that require storing in a container (e.g., a tank or reservoir) one or more fluids for certain amounts of time or for processing the one or more fluids, and then providing the one or more fluids to another component of the refinery for further processing. These fluids are sometimes not pure fluids, i.e., they include one or more other particulates, which tend to sediment in time. Thus, in time, the tanks or reservoirs where these fluids are customarily stored or processed, start to accumulate these particulates as residue (called herein “sediment”). Over enough time, the amount of sediment may negatively interfere with the processing operations of the refinery (or any other plant). While this specific example refers to oil and gas processing, most chemical processing industries experience the same problems. In fact, even industries like food processing or pharmaceuticals are facing the same problems.

To remove the sediment, the assignee of this patent application has developed a specialized slurry dispensing system (also called cleaning device or cleaning system in this document) that can be placed inside the tank for removing the sediment with minimum disruption to the processing of the fluid. This system, called herein the Octopus, is described in International Patent Publication Application no. PCT/US2023/010320, filed on Jan. 6, 2023, the entire content of which is incorporated herein by reference. This patent application discloses that the Octopus system is attached to the interior of the tank by using various mechanical or magnetic means. Other cleaning systems for removing the sediment from a tank are today in use and compatible with the embodiments that are discussed later.

All the traditional cleaning systems need to be connected to a water source and also to a sediment collection system for removing the sediment from the container. For example, FIG. 1 illustrates a connecting system 100 that provides water and offers storage space for the sediment. The connecting system 100 may be fluidly connected to one or more cleaning devices 160-1, 160-2 (for example, Octopus, which are generically indicated by reference number 160-I, where I may be any positive integer equal to or larger than 1), which are located inside an operational tank 162.

The connecting system 100 includes a motive water delivery system 110 and a slurry receiving system 130. The delivery system 110 includes a water tank 112 that holds the water necessary for cleaning the inside the operational tank 162. The water from the water tank 112 is pumped by a pump 114 through various piping 116 and intake valves 118 to each cleaning device 160-I. The receiving system 130 includes a receiving tank 132 for storing the sediment that is removed from the operational tank 162. Plural pipes 134 and discharge valves 136 fluidly connect the discharge of the cleaning device 160-I to the receiving tank 132. Thus, each cleaning device 160-I is fluidly connected to a water delivery pipe 120 of the delivery system 110 and a sediment removing pipe 138 of the connecting system 100.

However, the existing connecting systems 100 are expensive (requiring a significant capital investment), static (difficult if not impossible to be moved to another tank), are difficult to be customized, and require local water availability and local sediment storage facilities. Thus, there is a need for a new connecting system, among the cleaning devices, a water source, and a sediment storage tank, that overcomes the above noted limitations.

### SUMMARY OF THE INVENTION

According to an embodiment, there is an independent control manifold for handling supplying a cleaning fluid to and extracting a sediment from an operational tank. The control manifold includes a supply block configured to receive the cleaning fluid from an external first tank and to supply the cleaning fluid to the operational tank, a discharge block configured to receive the sediment from the operational tank and to supply the sediment to an external second tank, and a venturi eductor that fluidly connects the supply block to the discharge block, and is configured to either extract the sediment from the operational tank or to recover the cleaning fluid.

According to another embodiment, there is a cleaning truck for supplying a cleaning fluid and extracting a sediment from an operational tank. The cleaning truck includes a tank for storing the cleaning fluid and the sediment and a control manifold located outside the tank. The control manifold includes a supply block configured to receive the cleaning fluid from the tank and to supply the cleaning fluid to the operational tank, a discharge block configured to receive the sediment from the operational tank and to supply the sediment to the tank, and a venturi eductor fluidly connecting the supply block to the discharge block, and configured to either extract the sediment from the operational tank or to recover the cleaning fluid from the tank.

According to yet another embodiment, there is a method for removing a sediment, with a control manifold, from an operational tank. The method includes supplying a first cleaning fluid, with a supply block of the control manifold, to an inlet of the operational tank, discharging the sediment, with a discharge block of the control manifold, from an outlet of the operational tank, diverting a part of the first cleaning fluid, from the supply block to a first inlet of a venturi eductor to create a vacuum at a second inlet, and pulling in a fluid, at the second inlet of the venturi eductor.

### BRIEF DESCRIPTION OF THE DRAWINGS

For a detailed description of the disclosed, representative embodiments, reference will now be made to the accompanying drawings, which include the following figures, wherein:

FIG. 1 is a schematic diagram of a cleaning system located in a tank and a connecting mechanism that provides water to the cleaning system and stores the sediment removed from the tank by the cleaning system;

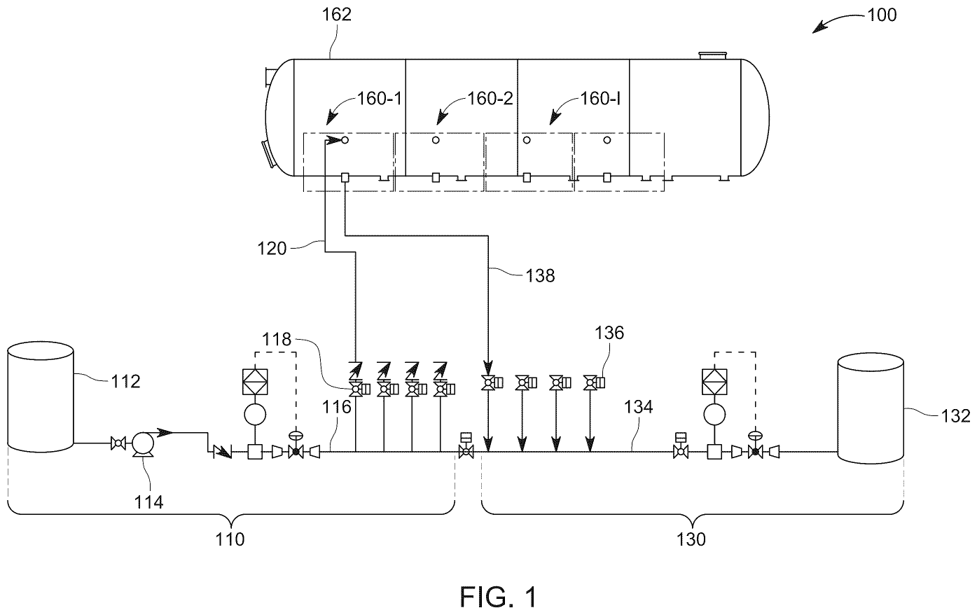

FIG. 2 is a schematic diagram of a system that uses two trucks for cleaning a tank with a cleaning system located inside the tank;

FIG. 3 is a schematic diagram of another system that uses two trucks and an independent control manifold for connecting the two trucks to a cleaning system located inside the tank;

FIG. 4 is a schematic diagram of the independent control manifold and its connections to two trucks and the cleaning system according to an embodiment;

FIG. 5 is a schematic diagram of the independent control manifold and its connections to two trucks and the cleaning system according to another embodiment;

FIG. 6 is a schematic diagram of the independent control manifold and its connections to two trucks, an external tank, and the cleaning system according to an embodiment;

FIG. 7 is a schematic diagram of the independent control manifold and its connections to a single truck, an external water supply, and a cleaning system according to an embodiment;

FIG. 8 is a schematic diagram of the independent control manifold and its connections to a fixed water supply, an external tank for storing a sediment, and a cleaning system according to an embodiment;

FIG. 9 is a schematic diagram of the cleaning system;

FIG. 10 is a schematic diagram of the control manifold being attached to a truck according to an embodiment;

FIG. 11 is a schematic diagram of the control manifold of FIG. 10 being attached to the truck;

FIG. 12 is a schematic diagram of the control manifold of FIG. 10;

FIG. 13 is a schematic diagram of the truck, its control manifold, and the various connections to an operational tank; and

FIG. 14 is a flow chart of a method for cleaning an operational tank with the control manifold of any of FIGS. 3 to 12.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

In various embodiments, an independent control manifold is provided on a movable platform (called herein simply the “platform”) and this assembly (called “control manifold assembly”) may be dispatch, as needed, to an operational tank for removing the inside sediment. The control manifold assembly may be fluidly connected to a truck (e.g., water supply truck, and/or sediment storage truck) for distributing the water to the cleaning systems located inside the operational tank. The control manifold assembly may handle only the water supply part, only the sediment removal part, or both the water supply and the sediment removal parts. Details of the control manifold assembly and various possible implementations of it are now discussed with regard to the figures.

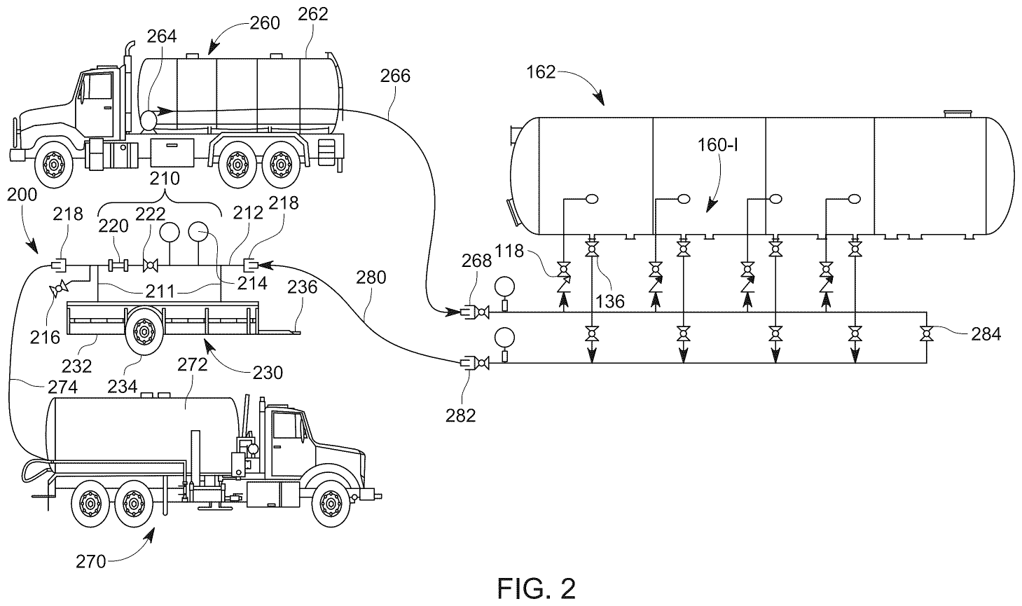

FIG. 2 illustrates the control manifold assembly 200 having the independent control manifold 210 supported (for example, with a frame 211) on the platform 230. Note that the term “independent” is used herein to indicate that the control manifold assembly 200 or its control manifold 210 are independent of the trucks, i.e., they can be moved where desired without the need of the trucks. The platform 230 may be a skid, for example, having a frame 232 and wheels 234. The frame 232 may have a connecting mechanism 236 for connecting to a vehicle for being towed. The control manifold 210 may include pipes 212, a measurement device 214 (for example, a flow meter, pressure device, temperature sensor, etc.), various valves 216, connection ports 218, sight element 220, and choke valve 222. The connection ports 218 (e.g., female and/or male camlocks) are used to connect to various houses of the trucks or the operational tank, and/or the cleaning systems. The sight element 220 includes at least a transparent wall portion so that the operator can visually inspect the fluid/sediment being pumped through the control manifold. The choke valve 222 is used to control and/or suppress the flow of fluids through the control manifold. More elements may be added to the control manifold 210 as discussed later.

FIG. 2 shows a water supply truck 260 having a water tank 262, a pump 264 for pumping the water from the tank, and a flexible pipe (e.g., a hose) 266 for fluidly connecting the pump 264 to the cleaning device 160-I to supply the water. The figure shows connecting elements 268 and corresponding intake valves 118 connected along the water flow to the functional tank. FIG. 2 further shows a sediment storage truck 270 having a sediment storage tank 272 and a connecting hose/pipe 274 for fluidly connecting to the control manifold 210. The control manifold 210 is also fluidly connected, through a discharge conduit 280, to connecting elements 282 and corresponding discharge valves 136, which are fluidly connected to the cleaning devices 160-I inside the functional tank 162. The connecting elements 268 and 282 and the valves 118 and 136 are fixedly attached to the operational tank 162. Due to the above discussed connections, the water pumped from the water supply truck 260 reaches the cleaning devices 160-I, dislodges the sediment from the operational tank 162 and forms a slurry, and the slurry is discharged through the discharge valves 136 to the control manifold assembly 200 and then moved to the sediment storage truck 270, where it is stored. Note that in one embodiment, the pressure existing in the operational tank 162 makes the slurry to move along the path described above. A bypass valve 284 may directly connect the intake valves 118 to the discharge valves 136 for backflush or other purposes.

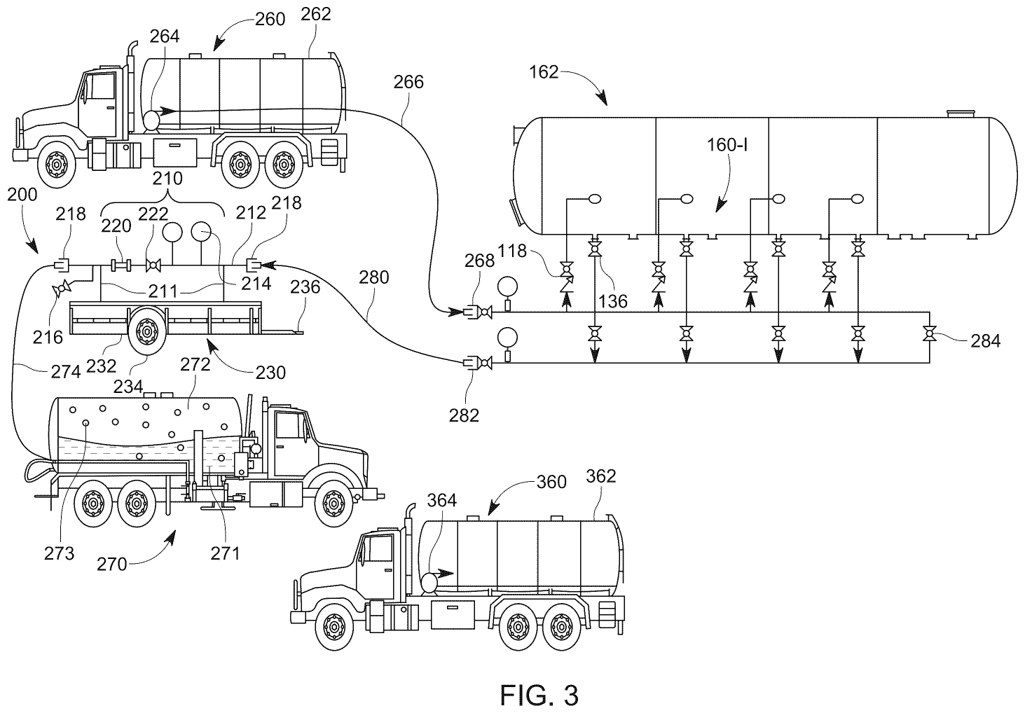

The cleaning system 200 illustrated in FIG. 2, e.g., control manifold assembly 200, water delivery truck 260, and sediment storage truck 270, requires that the trucks leave the job site to either get more water or unload the stored sediment, which is time consuming and expensive. Thus, according to an embodiment, as schematically illustrated in FIG. 3, a shuttle truck 360 is used to travel to a source of water and bring water for the water supply truck 260. The shuttle truck 360 has its own tank 362 for carrying the water and its own pump 364 (e.g., pressure pump, vacuum pump, or both) for pumping the water. The shuttle truck 360 may also be used to remove the sediment from the sediment storage truck 270 so that the sediment storage truck 270 does not have to leave the operational tank 162.

Thus, in one embodiment, the shuttle truck 360 is initially supplied with a full load of water. As the water truck tank 262 of the water supply truck 260 empties, water from the shuttle truck 360 is pumped into the water supply truck 260 to replenish its supply so that it can continue operating. After the shuttle truck 360 pumps its load of water into the water supply truck 260, it then uses its vacuum pump 364 to pull water from the sediment storage truck 270, which is receiving the sediment slurry from the cleaning device 160-I. Note that the slurry discharged from the operational tank 162, into the tank 272 of the sediment storage truck 270, separates due to the gravity into the sediment 271, which accumulates to the bottom of the tank 272, as schematically illustrated in FIG. 3, and a cleaning fluid (e.g., the clean water) 273, which stays at the top of the tank 272. Due to this separation, the shuttle truck 360 can pump this load of water back into the water supply truck 260, when needed. With this method, three trucks 260, 270, and 360 can be utilized to operate multiple cleaning devices 160-I, until the sediment storing truck 360 contains the maximum weight of solids that it can carry.

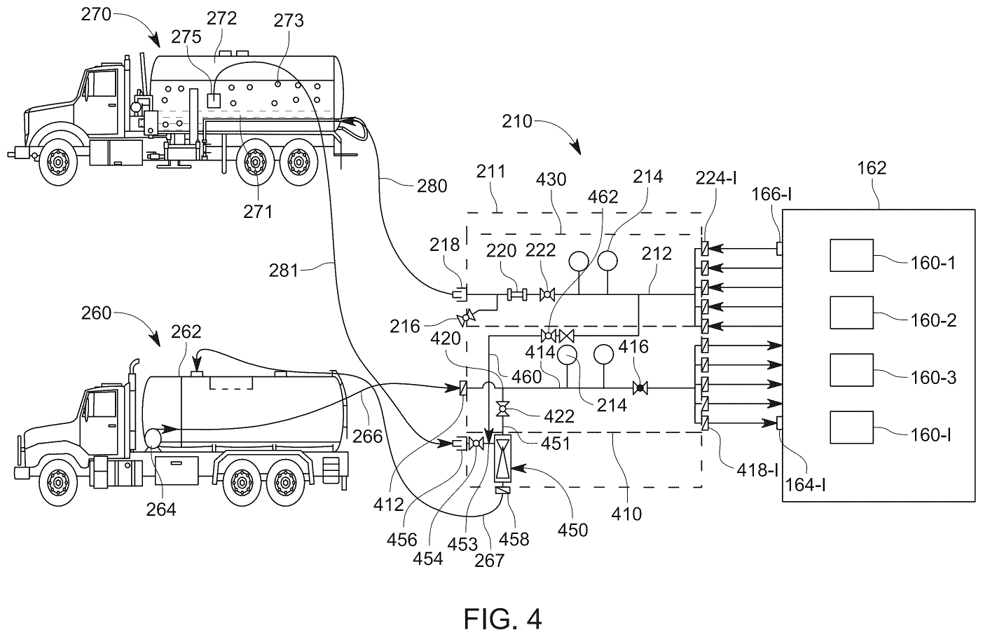

In another embodiment, as illustrated in FIG. 4, the control manifold 210 is configured to handle not only the discharge fluid from the operational tank 162, but also the water supply. In this embodiment, the control manifold 210 includes a supply block 410, a discharge block 430, and a venturi eductor 450 fluidly connected to each of the supply block and discharge block. The venturi eductor is a device having two inlets and an outlet. A first inlet is used to receive a first fluid (e.g., water), under pressure for generating a vacuum at a second inlet. The second inlet may be connected to any source of a second fluid (in one embodiment, the second fluid is the same as the first fluid, e.g., water; however, in another embodiment, the second fluid is the slurry that includes the sediment). The output discharges a mixture of the first and second fluids. Note that while the first inlet acts as the “engine” of the venturi eductor, the second inlet and the outlet act as a “vacuum cleaner.”

The control manifold 210 optionally includes the support 211, for being attached to the platform 230. The supply block 410 includes an inlet port 412 for fluidly connecting to the flexible pipe 266 providing water from the water supply truck 260. The inlet port 412 may be implemented as a camlock or any other known lock. The inlet port 412 is fluidly connected to a water supply pipe 414 that extends along the control manifold 210. The water supply pipe 414 may be provided with a control valve 416 that may be used to control the water flow entering the operational tank 162. The water supply pipe 414 terminates with one or more outlet ports 418-I, where I may be the number of cleaning devices 160-I located inside the operational tank 162. However, I may be larger or smaller than the number of cleaning devices inside the operational tank. The outlet ports 418-I are configured to fluidly connect to corresponding inlet ports 164-I of the operational tank 162. These ports are fluidly connected to inlet ports (not shown) of the cleaning devices. While FIG. 4 shows the presence of four cleaning devices 160-I, fewer or more cleaning devices may be used. The water supply pipe 414 may have a T-junction 420 that fluidly communicates, through another control valve 422, with the venturi eductor 450. By using the control valves 416 and 422, the operator of the control manifold 210 may control the amount of water flowing toward the cleaning devices 160-I and toward the eductor 450 (for example, only to the cleaning devices, only to the eductor, or to both of them in a desired split). The purpose of this control is discussed later. The supply block 410 may also include one or more sensors 214, e.g., pressure sensor, flowmeter, etc.

The discharge block 430 includes the discharge pipe 212, one or more sensors 214, a sample valve 216 (for sampling the discharged slurry), an outlet port 218 for connecting to the discharge conduit 280 (e.g., a hose, flexible or solid) and to the tank of the sediment storing truck 270. The discharge block 430 may also include the sight element 220, and the choke valve 222. The discharge pipe 212 is also connected to one or more inlet ports 224-I, where I may describe the number of cleaning devices 160. However, the number of inlet ports may be smaller or larger than the number of cleaning devices. The inlet ports 224-I are fluidly connected to corresponding outlet ports 166-I on the operational tank 162, that are fluidly connected to the discharge outlets (not shown) of the cleaning devices 160-I. All the ports of the control manifold 210 may be camlocks. In one application, only ports 218 and 412 are camlocks and ports 418-I and 224-I are hammer unions. In one application, a hammer union is a connection that joins two parts with a threaded nut, and is commonly used in the oil and gas industry. The nut has protrusions that can be hit with a sledgehammer to tighten the connection and energize the seals.

In addition, the control manifold 210 includes the venturi eductor 450, which is fluidly connected at a first inlet 451, to the water supply pipe 414, through the control valve 422. The venturi eductor 450 has a second inlet 453 that is fluidly connected to a ball valve (i.e., a valve that has on and off positions) 454. The second inlet 453 may also be fluidly connected to a crossover branch 460, which may include one or more valves 462 (e.g., ball valve). The crossover branch 460, when operational (i.e., the valve 462 is open), diverts the discharged slurry from the discharge block 430 to the eductor 450. The ball valve 454 is connected to a suction port 456, which is configured to be fluidly connected a hose 281, which, in this embodiment, skims the water surface of the sediment storage tank 272 of the sediment storage truck 270. The end of the hose 281 may be provided with a skimmer device 275, which floats at the surface of the water 273 inside the tank 272. The eductor 450 also has an outlet port 458, which may be fluidly connected to another flexible hose 267 for supplying the water from the tank 272 to the water tank 262 of the water supply truck 260. In other embodiments, the outlet port 458 of the eductor may be connected to a tank to discharge the sediment, as discussed later.

When in use (i.e., valve 422 is open), the eductor 450 is configured to receive, from the water supply pipe 414 of the water supply block 410, a certain water flow. This water flow is pumped by the pump 264 of the water supply truck 260, in addition to the water flow necessary for the cleaning devices 160-I. The water flow at the first inlet 451 creates a negative pressure at the suction port 456 of the eductor (a vacuum), which draws in the separated water 273 from the sediment storage truck 272. This water is then expelled by the eductor at the outlet 458, and supplied to the water tank 262 of the water supply truck 260. In this way, by diverting and using a fraction of the water flow from the water supply truck 260 to the eductor 450, it is possible to recycle the water from the sediment storage truck 270, which reduces the need for providing new water to the water supply truck 260 and for the sediment storage truck 270 to discharge its load. This method allows excess water that is carried in the slurry, from the cleaning devices 160, to be returned to the water supply truck 260, while the sediments from the slurry settle and remain in the tank on the sediment storage truck 270. This approach extends the capacity of both the water supply truck and sediment storage truck to enable multiple cleaning device to be operated until the sediment storage truck is filled with solids to a point that it reaches its maximum carrying weight of solids.

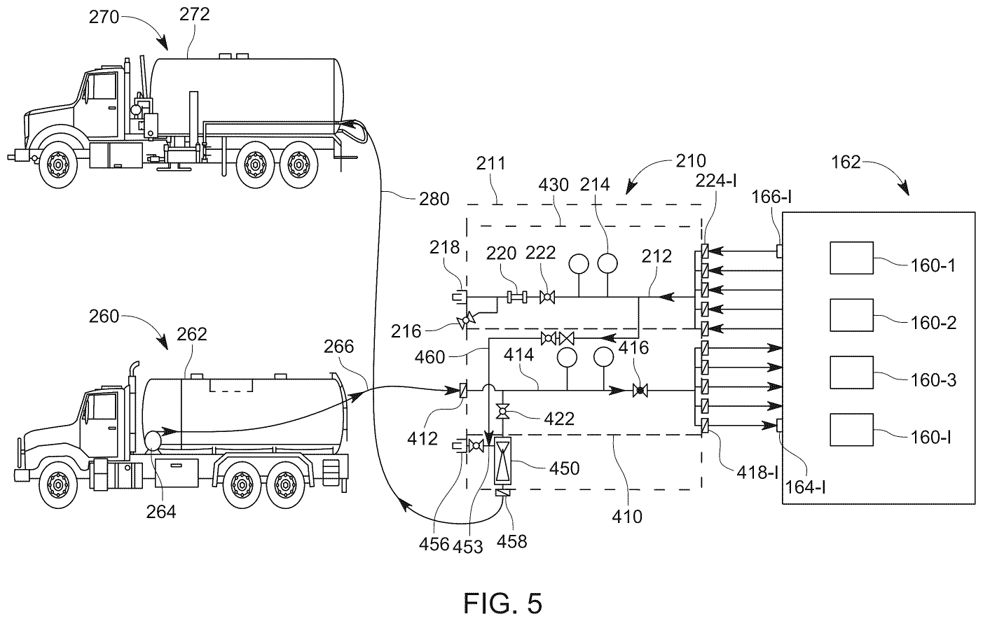

The above embodiments assume that the operational tank 162 is operating under a given pressure due to its role in the plant to which it belongs. This pressure helps to discharge the slurry from the tank, into the discharge block 430. However, there are situations when the operational tank 162 is not under pressure, or its operation pressure is not enough to discharge the slurry into the discharge block 430. For these situations, the crossover branch 460 of the control manifold 210 is used to fluidly connect the discharge pipe 212 to the suction port 453 of the eductor 450. Thus, this feature enables operation of the cleaning devices 160-I in a low pressure tank as the eductor 450 provides the necessary negative pressure for discharging the slurry from the operational tank 162. This configuration is illustrated in FIG. 5. Note that for this configuration, the choke valve 222 is closed, so that there is no need for a hose to be connected to port 218, for discharging the slurry to the sediment storage truck 270. The slurry is now discharged through the crossover branch 460, eductor 450, and conduit 280 to sediment storage tank 272 of the sediment storage truck 270. No water is recycled for this embodiment, from the sediment storage tank to the water supply tank as the eductor 450 is used to pump out the slurry.

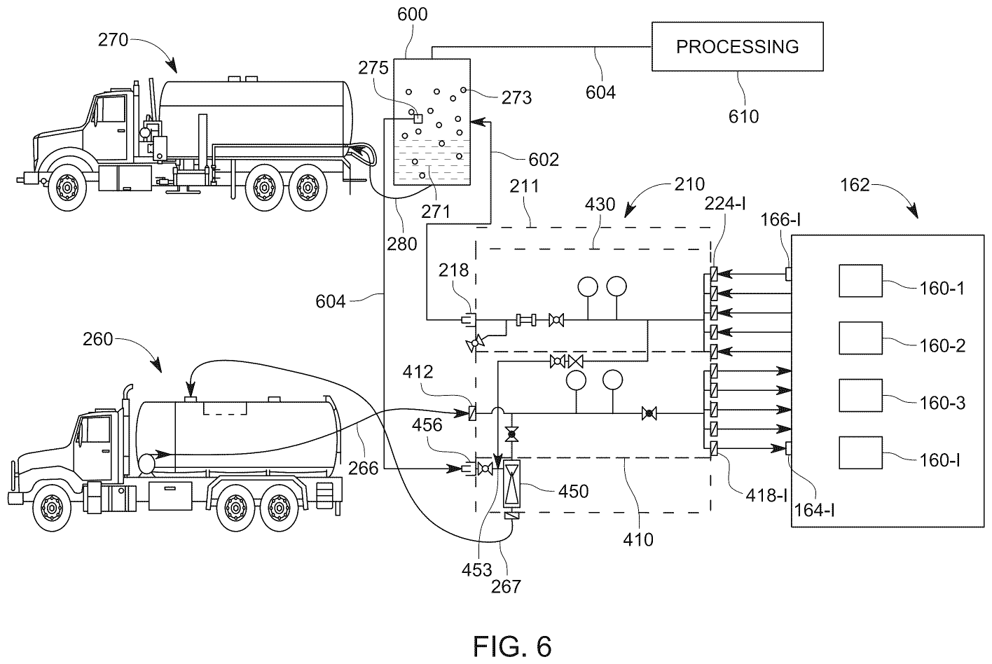

In another embodiment, as illustrated in FIG. 6, a collection tank 600 is added to the system to replace the sediment storage truck 270. Thus, although the sediment storage truck 270 is shown in the figure, its presence is not necessary. The sediment storage truck 270 may be used to empty the collection tank 600, by using, for example, a pump and a conduit 280 connected to the bottom of the collection tank. The outlet port 218 of the discharge block 430 is fluidly connected through a pipe (or hose) 602 to the collection tank 600 for discharging the slurry, which separates into the sediment 271 and water 273. A pipe (or hose) 604 may fluidly connect the inside of the collection tank 600, at a height where it is expected to be only water, to the suction port 456 of the eductor 450. In one variation of this embodiment, the skimmer device 275 may be used to maintain the end of the pipe 604 at the water surface inside the collection tank 600. For this case, the end of the pipe 604 is flexible, so that it follows the skimmer device 275 as it moves with the water surface inside the tank.

The collection tank 600 in this embodiment provides two advantages to an oil and gas producer. The first advantage permits the system to be operated safely in the presence of high levels of potentially harmful gases, such as H₂S, methane, or others, that may be present in the slurry, which is removed with the cleaning devices 160-I. The collection tank 600 also allows a connection 604, from the top of the connection tank, back to an onsite flare or tank vapor recovery system 610, that safely captures the harmful gases. The second advantage of the collection tank 600 is the elimination of the sediment storage truck 270 from the site, during operation of the cleaning devices. The solids removed with the cleaning devices can be stored onsite, in the collection tank 600, and removed periodically, with the sediment storage truck. This may lower trucking costs for the operator of the operational tank 162.

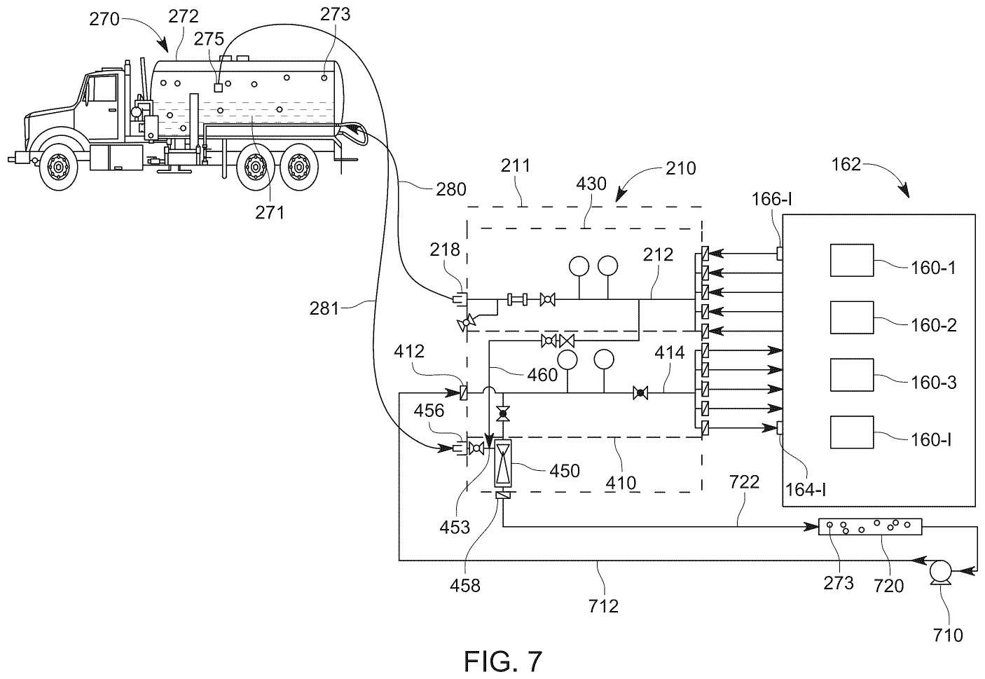

In another embodiment, as illustrated in FIG. 7, the water supply truck 260 is not present. For this embodiment, a pump 710 is provided next to a local water source 720 (e.g., associated with the plant or refinery that runs the operational tank 162) and provides the necessary water to the control manifold 210. In this embodiment, the water source 720 may be a tank or a water supply line. The pump 710 is fluidly connected to the inlet port 412 of the water supply block 410. For this embodiment, the suction valve 456 of the eductor 450 is connected to the water of the sediment storage tank 272, of the sediment storage truck 270, similar to the configuration shown in FIG. 4, so that water from the sediment storage truck 270 is recycled to the water supply 720, along a return water pipe 722. Thus, in this embodiment, the pump 710 delivers water 273 to the cleaning devices 160-I and also provides water to the eductor 450 to recover water from the sediment storage tank 272 and return it to the onsite water supply 720.

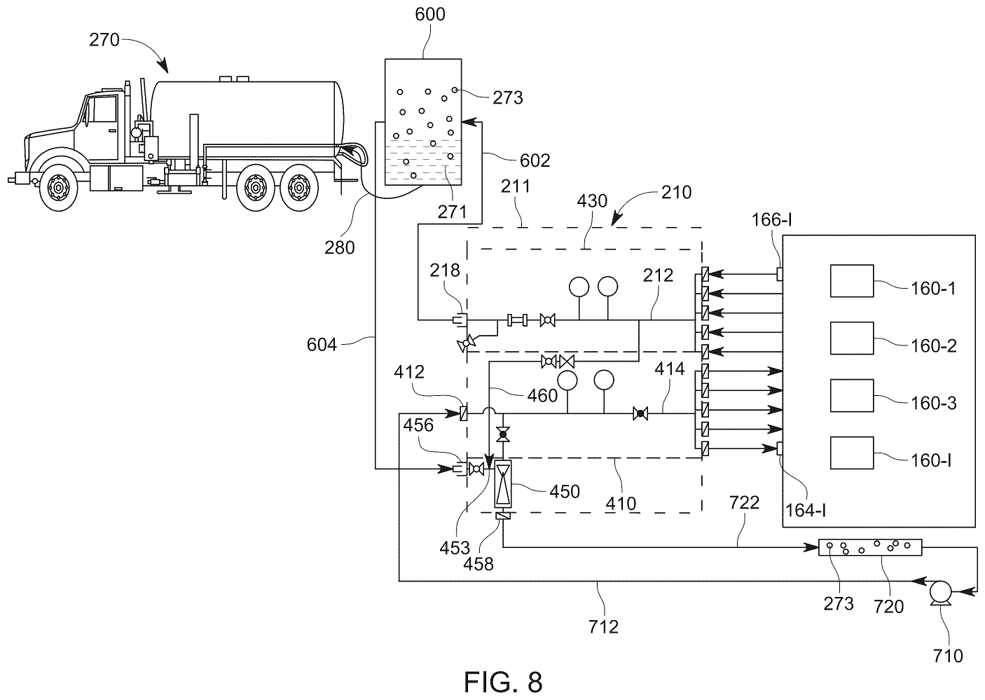

In yet another embodiment, as illustrated in FIG. 8, it is possible to have neither the water supply truck 260 nor the sediment storage truck 270 as the local water supply 720 of the embodiment of FIG. 7 is used for supplying the water to the control manifold 210, and the collecting tank 600 of the embodiment of FIG. 6 acts as the sediment storage tank. Although FIG. 8 shows the sediment storage truck 270, the sediment storage truck 270 is not required for the operation of the cleaning devices 160-I. The sediment storage truck 270 is shown in this figure to suggest that the collection tank 600 may be emptied, when desired, with the sediment storage truck 270. In this embodiment, the eductor 450 is used to recycle the water from the tank 600, i.e., to bring it back to the water source 720.

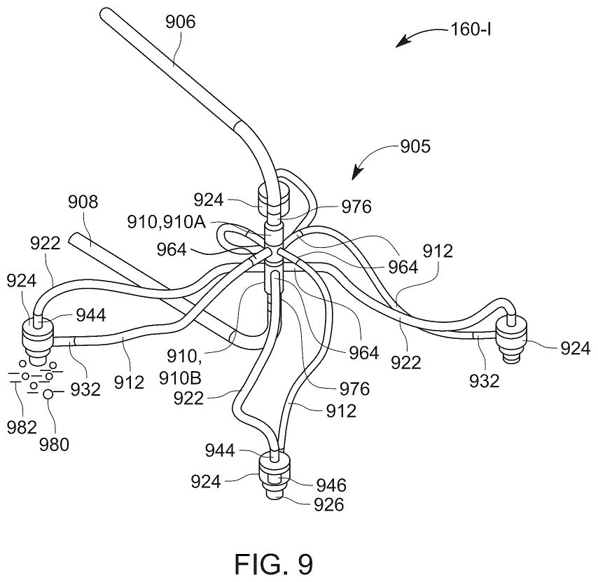

One example of a cleaning device 160-I used to clean the operational tank 162 discussed above is illustrated in FIG. 9. Note that other cleaning devices may be used with the control manifold 210. FIG. 9 presents a cleaning device 160-I that is based on cyclonic jetting. The cleaning device 160-I is configured to deliver a fluid (e.g., water) inside the tank 162 and extract a slurry from the tank. During delivery, the fluid may be a liquid, a gas, or a mixture, and during extraction, the fluid may be part of the slurry. In this embodiment, the cleaning device 160-I includes a slurry intake assembly 905 coupled to an inlet line 906 and an outlet line 908. During operation, inlet line 906 serves as a flow path for delivering the water (or other fluids) from the water supply truck 260. In this and some other embodiments, inlet line 906 includes flexible piping. During operation, outlet line 908 serves as a flow path for the slurry discharge to the sediment storage truck 270, which is retrieved through intake assembly 905. In this and some other embodiments, outlet line 906 includes flexible piping. In some embodiments, inlet line 906 or outlet line 908 is formed with rigid piping lacking flexible piping.

When multiple cleaning devices 160-I are used together in the operational tank 162, the cleaning devices 160-I may be flow balanced or internally flow balanced with respect to each other by using equal lengths of outlet lines 908 or by another arrangement. Some of those or other embodiments with multiple cleaning devices 160-I are configured to have equal lengths of inlet lines 906, making the inlet lines flow balanced. In some embodiments, inlet line 906 and outlet line 908 are considered to be members of slurry intake assembly 905.

Slurry intake assembly 905 includes a hub manifold assembly 910 coupled to a plurality of fluidizers 924 by pairs of distribution lines 912 and gathering lines 922 for fluid communication. The hub manifold assembly 910 includes an inlet manifold 910A, having a combined flow port 976 coupled to inlet line 906 as a manifold inlet port for fluid communication, and having multiple distributed ports 964, with each distributed ports 964 coupled to one of the distribution lines 912 for fluid communication. The hub manifold assembly 910 further includes an outlet hub manifold 910B, having a combined flow port 976 coupled to outlet line 908 as a manifold outlet port for fluid communication, and having multiple distributed ports 964, with each distributed ports 964 coupled to one of the gathering lines 922 for fluid/slurry communication. Because distribution lines 912 and gathering lines 922 are flexible, they can be moved relative to hub manifolds 910A, 910B while they are fluidically connected to hub manifolds 910A, 920B. As a result, fluidizers 924 may be repositioned while remaining fluidically coupled to lines 912, 922 and hub manifolds 910A, 910B. In some embodiments, the distribution lines 912 and gathering lines 922 are flexible hoses. In some embodiments, the slurry intake assembly 905 is flow balanced by using equal lengths of gathering line 922 for the multiple fluidizers. Some of these or other embodiments of slurry intake assembly 905 are configured to have equal lengths of distribution lines 912, making the distribution lines flow balanced.

Continuing with FIG. 9, each fluidizer 924 includes a fluid inlet 932 to receive a supplied fluid, includes an open end 926 to discharge the supplied fluid 980 into a volume and to generate a slurry 982, by mixing the particulates in the tank with the fluid, and to extract/receive the slurry 982, from the volume, and includes a slurry exit 944 to deliver the received slurry to a destination (outlet hub manifold 910B). The slurry received from the volume may be similar to the supplied fluid, or may be a solution with dissolved solids or a slurry formed from the supplied fluid, as examples. The open end 926 of fluidizer 924 includes an annular fluid exit and a slurry inlet, but in some embodiments, open end 926 and the fluid exit are configured differently than an annular passage disposed about the slurry inlet.

Fluidizer 924 includes a mounting feature, which in this example is a mounting bracket 946 disposed on the body of each fluidizer 924 and spaced apart from fluid inlet 932 and slurry exit 944. For each fluidizer 924, the fluid inlet 932 is coupled to a distribution line 912 to receive a supplied fluid from the inlet hub manifold 910A, which is therefore arranged to perform as a fluid distribution source, and slurry exit 944 is coupled to a gathering line 922 to deliver the received slurry/fluid to the outlet hub manifold 910B, which is therefore arranged to perform as a gathering manifold with respect to the multiple fluidizers 924.

The cleaning device 160-I shown in FIG. 9 includes four fluidizers 924. Some other embodiments may have more or fewer fluidizers 924, and the hub manifold assembly 910 (or equivalently 910A, 910B) may be modified or partially capped to accommodate the different quantity of fluidizers. As examples, in various embodiments, a hub manifold assembly 910 may be modified and coupled to two, three four, or five fluidizers, and some embodiments may accommodate six, seven, or eight fluidizers 924 or more or similar quantities of fluidizers of another design. Slurry intake assembly 905 may be flowed balanced for the several fluidizers. Other embodiments may include still more fluidizers coupled to hub manifold assembly 910, up to a practical limit based on space or another engineering principle. As an example, the successful use of any particular number of fluidizers will depend, at least in part, on the pumping power available for delivering fluid to slurry intake assembly 905.

It should be noted that hub manifold assembly 910 and slurry intake assembly 905 may be coupled to a quantity of fluidizers that is not divisible by the number two. Some embodiments have an even number of fluidizers while other embodiments have an odd number fluidizers coupled to an appropriately configured hub manifold assembly 910, which may be configured and plumbed to achieve balanced flow among the multiple fluidizers. The balancing of flow may be achieved whether the hub manifold assembly 910 is distributing flow to or receiving fluid from the multiple fluidizers. Typically, another similar hub manifold assembly 910 with the same number of connections would be installed to perform the other task, for example, to receive or distribute flow.

Alternatively, some embodiments of slurry intake assembly 905 may instead include multiple hub manifolds plumbed to perform as outlet manifolds and a single, larger hub manifold with a sufficient number of distributed ports 964 could be installed to perform as an inlet manifold. Thus, for a particular slurry intake assembly, a larger, inlet hub manifold may have more distributed ports than any of the multiple outlet hub manifolds positioned to receive fluid or slurry from the fluidizers. The opposite arrangement is also possible, using multiple inlet hub manifolds in conjunction with a single, larger capacity outlet hub manifold. The flexibility in the selection of the number of flow paths and coupled fluidizers is based on the hub configuration of the hub manifold assembly 910, which includes a plurality of circumferentially distributed ports 964 to achieve a circumferentially distributed flow pattern. Circumferentially distributed ports 964 may uniformly distribute fluid to or gather fluid from multiple lines simultaneously. Ports 964 may also be arranged to follow another pattern, different from the circumferential pattern. The incoming and outgoing flow paths depend on how a particular hub manifold is plumbed to adjacent equipment. In the embodiment shown, hub manifolds 910A and 910B are further augmented by the use of flexible lines between the hub manifolds and the fluidizers. The multiple, circumferentially distributed ports 964 configure the hub manifold assembly 910 to have a generally radial pattern of flow paths leading to or emanating from a shared outlet or inlet flow path.

In FIG. 9, distributed ports 964 of hub manifolds 910A, 910B are coupled to the flexible distribution lines 912 and flexible gathering lines 922, respectively. By these connection lines, fluidizers 924 are each coupled to a distributed port 964 of distributing hub manifold 910A and to a distributed port 964 of gathering hub manifold 910B for fluid communication. In FIG. 9, each distributed port 964 is coupled to a single fluidizer 924.

The independent control manifold 210 discussed in the previous embodiments has been implemented on the platform 230, thus forming a control manifold assembly 200. This is advantageous because the control manifold 210 becomes independent of the trucks 260, 270 or the operational tank 162, which means that the control manifold 210 may be moved at any desired operational tank, independent of the presence of the trucks (i.e., it is portable). This not only reduces the cost of removing the slurry from the tanks, but also reduces a time necessary to prepare the entire system for sediment removal and also the capital investment for the operator of the control manifold.

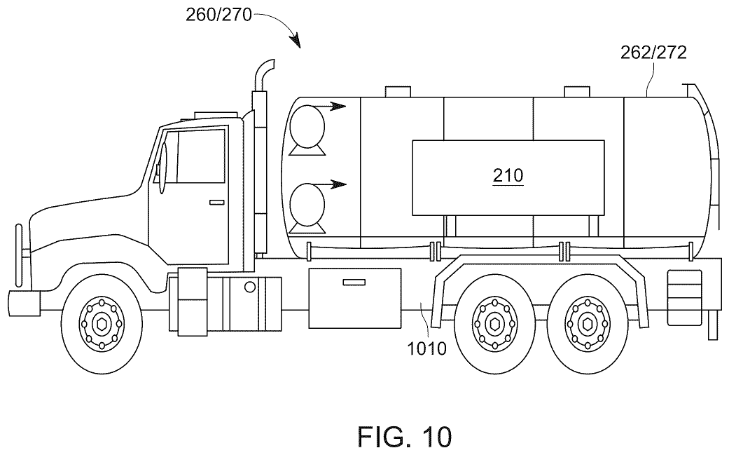

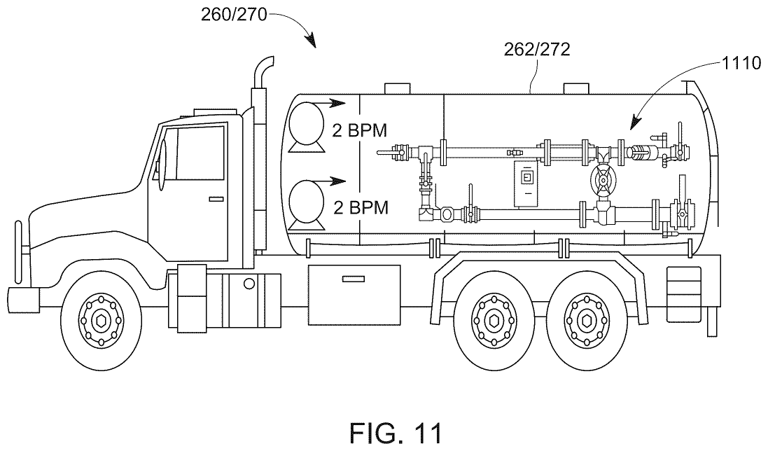

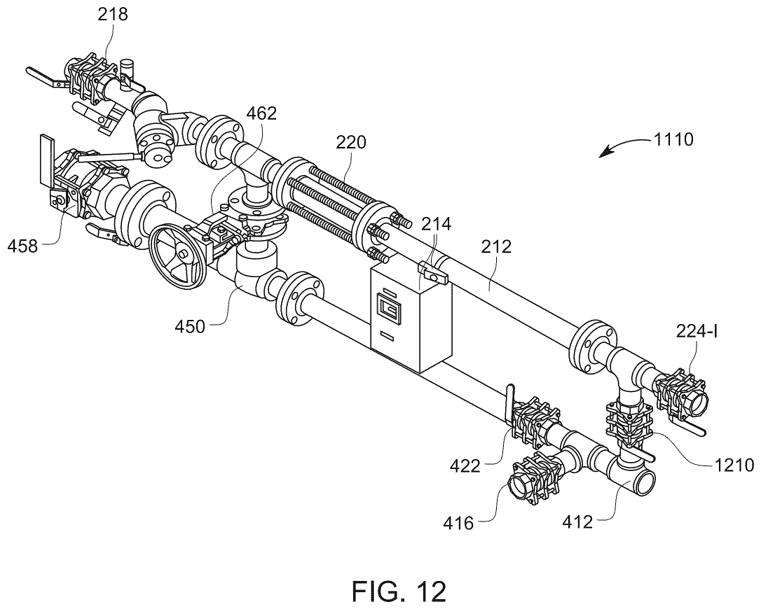

However, in another embodiment, as illustrated in FIG. 10, it is possible to place the control manifold 210 on one of the trucks 260 or 270. The control manifold 210 may be directly attached to a chassis 1010 of the truck or to the tank 262/272. In one embodiment, a control manifold 1110 may be implemented, as illustrated in FIG. 11, on the truck 260/270, with a similar or different configuration than the control manifold 210. The control manifold 1110 includes some of the elements of control manifold 210, as illustrated in FIG. 12, but differently connected. In addition, the control manifold 1110 includes a bypass valve 1210 that may fluidly connect the inlet port 412 (for the water supply) to the inlet port 224 (for receiving the slurry from the cleaning devices 160-I). Note that the inlet port 224 in this embodiment is configured to act as a valve, e.g., ball valve. While FIG. 12 shows a single port 224, in one embodiment, it is possible to have plural ports 224-I, as shown in the embodiment of FIG. 4, depending on the number of cleaning devices to be serviced.

In operation, the various valves of the control manifold 1110 are controlled as follows. If the control manifold 1110 is used for sediment removal from an operational tank under pressure, then the water supply from the water supply truck is provided to port 412, the valve 422 that controls the water flow to the eductor 450 is closed, and the valve 416 that controls the water flow to the intake of the cleaning device 160-I is open, so that the water is supplied to the cleaning device. The bypass valve 1210 is closed so that the supplied water does not mix up with the slurry received at port 224. The port/valve 224 is open for this scenario so that the slurry flows along pipe 212 to connection port 218, which is fluidly connected to the sediment deposit tank 272 of the truck 270 or the collection tank 600.

However, if the operational tank 162 is not under pressure, or its pressure is too low to pump the slurry to the port 224, then the control manifold 1110 is reconfigured to (partially) close valve 416, (partially) open valve 422, so that a water flow is provided to the eductor 450, to provide a vacuum effect in the pipe 212, to suck the slurry from the port 224, through the valve 462. Port 218 is closed for this scenario. In this case, the sediment storage tank 272 of truck 270 is connected to outlet port 458, and the outlet port 458 is opened, so that the slurry from the operational tank 162 flows to the sediment storage tank 272.

The valves shown in FIG. 12 may be further configured to allow a backflush of the cleaning device 160-I. For example, if the operational tank is under pressure, the bypass valve 1210 is opened, valves 422 and 416 are closed, port 218 is closed, and valve 462 is closed, and thus, the water supplied at port 412 moves through port 224 to the slurry line of the cleaning device for backflushing. If a flushing of the control manifold to the sediment storage tank 272 is desired, the bypass valve 1210 is opened, valves 416 and 422 are closed, port 224 is closed, valve 462 is closed, and port 218 is open, so that the flush liquid moves along pipe 212 and exits port 218 and then moves into the sediment storage tank 272 of the sediment storage truck 270.

For the backflush of the operational tank when under low pressure, the water is provided at port 412, valve 416 is closed, valve 422 is opened, port 224 is open, valve 462 is partially opened, port 458 is open and connected to the sediment storage tank, and port 218 is closed. For the backflush of the slurry line of the cleaning device 160-I when the operational tank 162 is at low pressure, all the ports and valves are closed except for bypass valve 1210 and port 224.

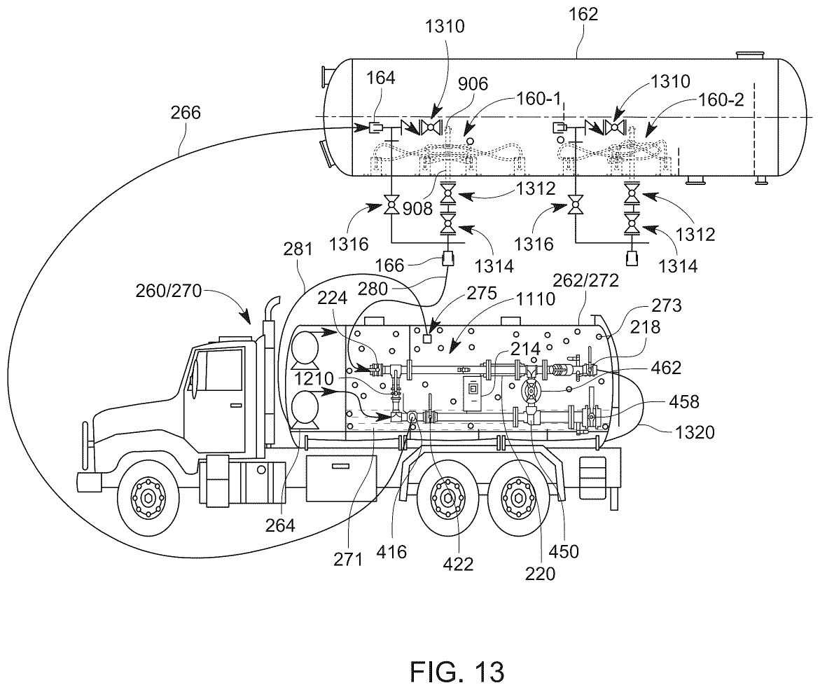

FIG. 13 illustrates a system in which a single truck 260 or 270 is provided with the control manifold 1110, which is attached outside the water tank 262. The figure also shows the connections to the operational tank 162, and the connections between these various elements. More specifically, FIG. 13 shows the skimmer device 275 floating in the water 273 inside the tank 262/272 of the truck 260/270. Note that initially, the water tank 262 for this embodiment is full of water, and, as the cleaning process of the operational tank 162 is progressing, sediment 271 starts to accumulate in the water tank 262, as a single truck 260 or 270 and a single tank 262 or 272, are used. The pump 264 is fluidly connected to the skimmer device 275, for pumping the clean water 273, along pipe/hose 266, to the intake port 164 of the functional tank 162. A motive valve 1310 may be provided to the inlet line 906 for each cleaning device 160-1, 160-2 (only two shown in the figure, but more or less may be used for a given operational tank) in the operational tank 162. The outlet line 908 of each cleaning device is provided with a corresponding slurry isolation valve 1312 and a slurry operating valve 1314, as illustrated in FIG. 13. In one embodiment, these valves are optional. A bypass valve 1316 may fluidly connect the inlet port 164 to the connection port 166, as also shown in the figure. In this embodiment, the sediment extracted from the functional tank 162, along hose 280, is discharged inside the tank 272 at the connection port 218. Note that the fluid connection between the connection port 218 and the interior of the tank 272 may be achieved by a pipe connection 1320, as schematically illustrated in FIG. 13.

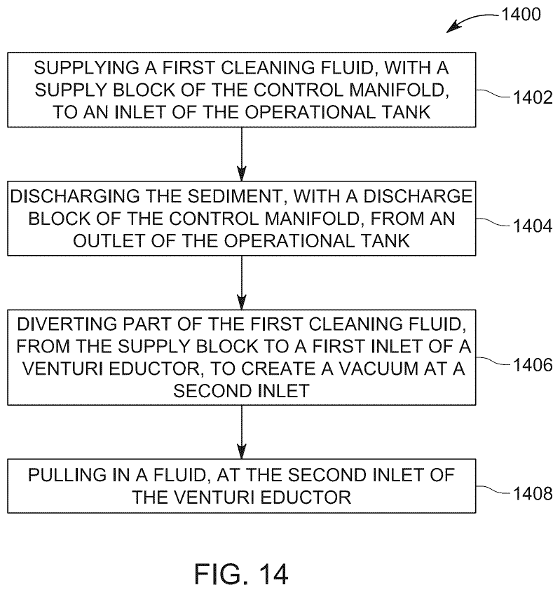

A method 1400 for removing the sediment 271, with the control manifold 210, from the operational tank 162, is now discussed with regard to FIG. 14. The method 1400 includes a step 1402 of supplying a first cleaning fluid (e.g., water, or a mixture of water and surface tension reducer, or other liquids), with the supply block 410 of the control manifold 210, to an inlet 164 of the operational tank 162, a step 1404 of discharging the sediment 271, with the discharge block 430 of the control manifold 210, from an outlet 166 of the operational tank 162, a step 1406 of diverting a part of the first cleaning fluid 273, from the supply block 410 to a first inlet 451 of a venturi eductor 450 to create a vacuum at a second inlet 453, and a step 1408 of pulling in a fluid, at the second inlet 453 of the venturi eductor 450.

In one embodiment, the fluid is a second cleaning fluid (e.g., water) from an external tank, which is filled with water and sediment, as illustrated in FIGS. 4, 6, 7, and 8. In another embodiment, the fluid is a mixture of water and sediment extracted from the operational tank, as illustrated in FIG. 5.

The method may further include a step of providing an output of the venturi eductor to a water only supply tank, as shown in FIGS. 4, 6, 7, and 8. Alternatively, the method may include providing an output of the venturi eductor to a water and sediment tank, as shown in FIG. 5.

The method may also include a step of recycling the first cleaning fluid, from a tank that stores the sediment, by skimming the first cleaning fluid from the tank and supplying the skimmed first cleaning fluid to the supply block. In this or another embodiment, the sediment is discharged in a same tank from which the first cleaning fluid is supplied.

While a number of embodiments have been shown and described, modifications thereof can be made by one of ordinary skill in the art without departing from the scope or teachings herein. The embodiments described herein are examples only and are not limiting. Many variations, combinations, and modifications of the systems, apparatuses, and processes described herein are possible and are within the scope of the disclosure. Accordingly, the scope of protection is not limited to the embodiments described herein, but is only limited by the claims that follow, the scope of which shall include all equivalents of the subject matter of the claims. The inclusion of any particular method step or operation within the written description or a figure does not necessarily mean that the particular step or operation is necessary to the method. The steps or operations of a method listed in the specification or the claims may be performed in any feasible order, except for those particular steps or operations, if any, for which a sequence is expressly stated. In some implementations two or more of the method steps or operations may be performed in parallel, rather than serially.

One of ordinary skill in the art will understand that the above description has broad application, and the discussion of any embodiment is meant to be exemplary of that embodiment, and is not intended to suggest in any way that the scope of the disclosure, including the claims, is limited to that embodiment.

The figures are not drawn to scale. Certain features or components disclosed herein may be shown exaggerated in scale or in somewhat schematic form, and some details of some elements may not be shown in the interest of clarity and conciseness. In some of the figures, in order to improve clarity and conciseness, one or more components or aspects of a component may be omitted or may not have reference numerals identifying the features or components. In addition, within the specification, including the drawings, like or identical reference numerals may be used to identify common or similar elements.

As used herein, including in the claims, the terms “including” and “comprising,” as well as derivations of these, are used in an open-ended fashion, and thus are to be interpreted to mean “including, but not limited to . . . ” Also, the term “couple” or “couples” means either an indirect or direct connection. Thus, if a first component couples or is coupled to a second component, the connection between the components may be through a direct engagement of the two components, or through an indirect connection that is accomplished via other intermediate components, devices and/or connections. The recitation “based on” means “based at least in part on.” Therefore, if X is based on Y, then X may be based on Y and on any number of other factors. The word “or” is used in an inclusive manner. For example, “A or B” means any of the following: “A” alone, “B” alone, or both “A” and “B.” In addition, the word “substantially” means within a range of plus or minus 10%.

Furthermore, any reference to a relative direction or relative position is made for purpose of clarity, with examples including “top,” “bottom,” “up,” “upper,” “upward,” “down,” “lower,” “clockwise,” “left,” “leftward,” “right,” “rightward,” “internal, and “external”. For example, a relative direction or a relative position of an object or feature may pertain to the orientation as shown in a figure or as described. If the object or feature were viewed from another orientation or were implemented in another orientation or position, it may then be helpful to describe the direction or position using an alternate term.

As used herein, “piping” and “line,” when referring to plumbing, may be used interchangeably and may include any of the following, whether alone or in any combination: pipe, tubing, hose, fittings, or any other tubular member suitable for containing or moving a fluid in a system described herein. Therefore, the “piping” or “line” may include, as examples, any valve(s), instrument(s), or port(s) for controlling, measuring, or accessing a fluid in the line. The term fluid circuit may be descriptive of piping or a line disclosed herein. Other potential variations and supplements will be understood by those skilled in the art.

What is claimed is:

1. An independent control manifold for handling supplying a cleaning fluid to, and extracting a sediment from an operational tank, the control manifold comprising:
a supply block configured to receive the cleaning fluid from an external first tank and to supply the cleaning fluid to the operational tank;
a discharge block configured to receive the sediment from the operational tank and to supply the sediment to an external second tank; and
a venturi eductor that fluidly connects the supply block to the discharge block, and is configured to either extract the sediment from the operational tank or to recover the cleaning fluid.

2. The control manifold of claim 1, wherein the supply block comprises:
an inlet port configured to connect to a first hose for receiving the cleaning fluid;
a control valve fluidly connected to the inlet port;
one or more outlet ports configured to connect to an inlet of a cleaning device; and
piping fluidly connecting the inlet port to the control valve and the control valve to the one or more outlet ports.

3. The control manifold of claim 2, wherein the discharge block comprises:
one or more inlet ports configured to connect to an outlet of the cleaning device;
a choke valve fluidly connected to the one or more inlet ports;
a connection port configured to connect to a second hose for discarding the sediment; and
piping fluidly connecting the one or more inlet ports to the choke valve and the choke valve to the connection port.

4. The control manifold of claim 3, further comprising:
a cross-over branch that fluidly connects the piping of the discharge block to the venturi eductor, wherein the cross-over branch includes a valve.

5. The control manifold of claim 4, wherein the venturi eductor comprises:
a first inlet configured to be fluidly connected to the supply block;
a second inlet configured to be fluidly connected to the cross-over branch; and
an outlet port configured to be fluidly connected to an external third tank.

6. The control manifold of claim 5, wherein the external third tank is the external first tank and the second inlet port is fluidly connected to the external second tank.

7. The control manifold of claim 5, wherein the external third tank is the external second tank and the second inlet port is closed.

8. The control manifold of claim 5, further comprising:
a collection tank fluidly connected to the second inlet port of the venturi eductor, the collecting tank being the external second tank,
wherein the first inlet port of the venturi eductor is fluidly connected to the external first tank, and
wherein the connection port of the discharge block is fluidly connected to the collection tank.

9. The control manifold of claim 5, further comprising:
a skimming device configured to skim the cleaning fluid from the external second tank and provide the skimmed cleaning fluid to the second inlet port of the venturi eductor,
wherein the external second tank is the first external first tank.

10. The control manifold of claim 5, wherein the second inlet port of the venturi eductor is fluidly connected to the external second tank, the external second tank is the first external tank, and the connection port of the discharge block is fluidly connected to the external second tank.

11. The control manifold of claim 1, wherein the external second tank is one of a sediment storage tank associated with a sediment storage truck, the external first tank associated with a water storage truck, or a collection tank, which is independent of a truck.

12. The control manifold of claim 1, further comprising:
a platform configured to support the supply block, discharge block, and venturi eductor so that the control manifold is mobile and autonomous.

13. A cleaning truck for supplying a cleaning fluid and extracting a sediment from an operational tank, the cleaning truck comprising:
a tank for storing the cleaning fluid and the sediment; and
a control manifold located outside the tank and comprising:
a supply block configured to receive the cleaning fluid from the tank and to supply the cleaning fluid to the operational tank;
a discharge block configured to receive the sediment from the operational tank and to supply the sediment to the tank; and
a venturi eductor fluidly connecting the supply block to the discharge block, and configured to either extract the sediment from the operational tank or to recover the cleaning fluid from the tank.

14. A method for removing a sediment, with a control manifold, from an operational tank, the method comprising:
supplying a first cleaning fluid, with a supply block of the control manifold, to an inlet of the operational tank;
discharging the sediment, with a discharge block of the control manifold, from an outlet of the operational tank;
diverting a part of the first cleaning fluid, from the supply block to a first inlet of a venturi eductor to create a vacuum at a second inlet; and
pulling in a fluid, at the second inlet of the venturi eductor.

15. The method of claim 14, wherein the fluid is a second cleaning fluid from an external tank, which is filled with water and sediment.

16. The method of claim 14, wherein the fluid is a mixture of water and sediment extracted from the operational tank.

17. The method of claim 14, further comprising:
providing an output of the venturi eductor to a water only supply tank.

18. The method of claim 14, further comprising:
providing an output of the venturi eductor to a water and sediment tank.

19. The method of claim 14, further comprising:
recycling the first cleaning fluid, from a tank that stores the sediment, by skimming the first cleaning fluid from the tank and supplying the skimmed first cleaning fluid to the supply block.

20. The method of claim 14, wherein the sediment is discharged in a same tank from which the first cleaning fluid is supplied.
